(19) United States
(12) Patent Application Publication
(10) Pub. No.: US 2009/0189859 A1
(43) Pub. Date: Jul. 30, 2009

(54) COMPUTER INPUT DEVICE WITH A CLIP AND METHOD OF MANUFACTURING SAME

(75) Inventors: Barry Sween, Santa Monica, CA (US); Mike Simonian, San Francisco, CA (US); Maaike Evers, San Francisco, CA (US)

Correspondence Address: Bryan Cave, LLP, Suite 2200, Two North Central Avenue, Phoenix, AZ, 85004-4406, US

(73) Assignee: Belkin International, Inc., Compton, CA (US)

(21) Appl. No.: 12/022,629

(22) Filed: Jan. 30, 2008

(51) Int. Cl. G06F 3/033

(52) U.S. Cl. 345/163

(57) ABSTRACT

In a number of embodiments, a computer input device includes: (a) an outer casing having; (1) a first surface; (2) a second surface; and (3) a cavity between the first surface and the second surface; (b) at least one button at the first surface; (c) a mechanism configured to detect movement of the outer casing and located at the second surface; and (d) a dip. In these embodiments, the mechanism and the at least one button are at least partially located within the cavity. Other embodiments are disclosed in the application.

### FIELD OF THE INVENTION

This invention relates generally to an input device for a computer, and relates more particularly to a computer mouse and methods of manufacturing the same,

### DESCRIPTION OF THE BACKGROUND

Most laptops or portable computers have a touchpad, a pointing stick, and/or a computer mouse integrated with or around the keyboard. However, many people prefer to use a computer input device that is not integrally attached to the portable computer. Unfortunately, small, portable computer input devices are easily and often lost, forgotten, stolen, or damaged when a person moves the portable computer and the computer input device between locations.

Accordingly, a need exists for a computer input device that is portable and designed to help a user easily and securely transport the computer input device.

### BRIEF DESCRIPTION OF THE DRAWINGS

To facilitate further description of the embodiments, the following drawings are provided in which.

FIG. 1 is a right side view illustrating a computer input device, according to a first embodiment;

FIG. 2 is a top view illustrating the computer input device of FIG. 1, according to the first embodiment;

FIG. 3 is a cross-sectional view along line 3-3 of FIG, 2 illustrating the computer input device of FIG. 1, according to the first embodiment;

FIG. 4 is an exploded view illustrating the computer input device of FIG. 1, according to a first embodiment;

FIG. 5 is a right side view illustrating a computer input device, according to a second embodiment; and

FIG. 6 is a flow chart illustrating an embodiment of a method of manufacturing a computer input device.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are Interchangeable under appropriate circumstances such that the embodiments of the invention described herein are, for example, capable of operation in sequences other than those illustrated or otherwise described herein. Furthermore, the terms “include,” and “have,” and any variations thereof, are intended to cover a non-exclusive inclusion, such that a process, method, system, article, or apparatus that comprises a list of elements is not necessarily limited to those elements, hut may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “on,” as used herein, is defined as on, at, or otherwise adjacent to or next to or over.

The terms “couple,” “coupled,” “couples,” “coupling,” and the like should be broadly understood and refer to connecting two or more elements or signals, electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not he electrically coupled. Coupling (whether only mechanical, only electrical, or both) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable. For example, the recitation of a clip being coupled to an outer casing does not mean that the clip cannot be removed (readily or otherwise) from, or that it is permanently connected to, the outer casing.

### DETAILED DESCRIPTION OF EXAMPLES OF EMBODIMENTS

In a number of embodiments, a computer input device includes: (a) an outer casing having: (1) a first surface; (2) a second surface; and (3) a cavity between the first surface and the second surface; (b) at least one button at the first surface; (c) a mechanism configured to detect movement of the outer casing and located at the second surface; and (d) a clip. In these embodiments., the mechanism and the at least one button are at least partially located within the cavity.

In other embodiments, a computer mouse includes: (a) one or more buttons; (b) a movement sensing mechanism; and (c) a structure having: (1) a body defining an interior space; (2) a segment coupled to the body; and (3) an extension spaced apart from the body and coupled to the segment. The body and the segment define therebetween a first channel. In these embodiments, at least a portion of the one or more buttons and at least a portion of the movement sensing mechanism are in the interior space of the body.

In further embodiments, a computer mouse includes a housing having a clip, and two or more user input mechanisms located at least partially within the housing.

In yet another embodiment, a method of manufacturing a computer input device includes: (a) providing at least one button; (b) providing an outer casing; (c) providing a mechanism configured to detect movement of the outer casing; (d) at least partially enclosing the at least one button and the mechanism in the outer casing; and (e) integrally coupling a clip to the outer casing.

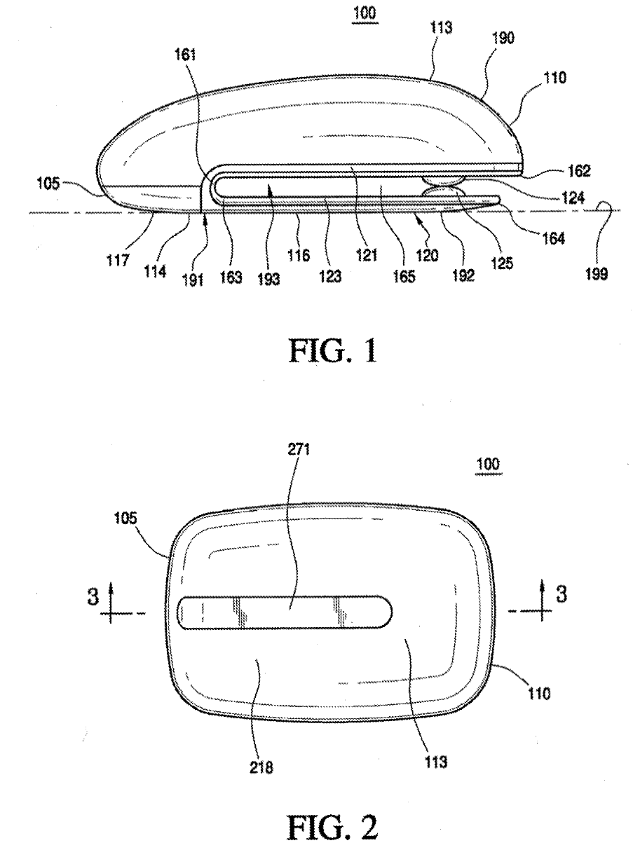

Turning to the drawings, FIG. 1 is a right side view illustrating a computer input device 100, according to a first embodiment. FIG. 2 is a top view illustrating computer input device 100, according to the first embodiment. Computer input device 100 is merely exemplary and is not limited to the embodiments presented herein. Computer input device 100 can be employed in many different embodiments or examples not specifically depicted or described herein.

Referring to FIGS. 1-2, a computer mouse or computer input device 100 can include: (a) a body, housing, or outer casing 110; and (b) a clip 120. In the example shown in FIG. 1, clip 120 is integrally formed or coupled to outer casing 110. In the same or different examples, outer casing 110 and clip 120 can form an exterior 105 of computer input device 100. In some examples, exterior 105 can have a surface 114 and a surface 113.

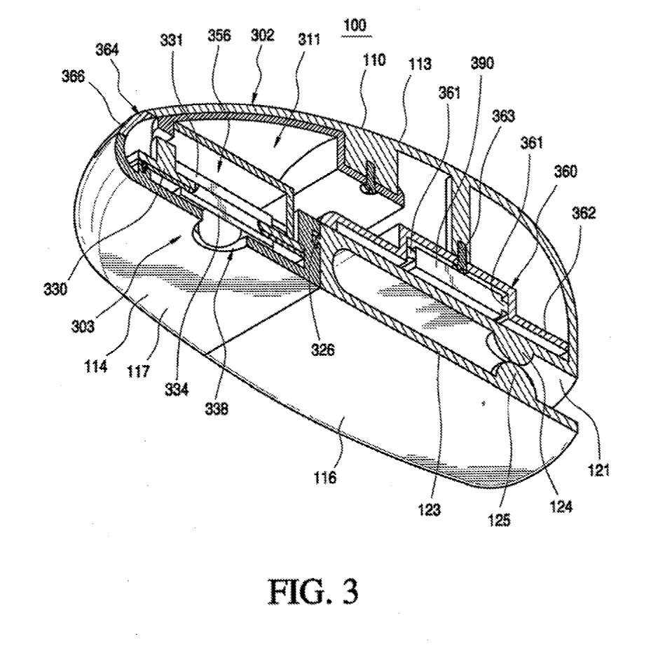

Referring to FIG. 1, clip 120 can include; (a) a main portion 121; (b) a tail portion 123; and (c) an attachment mechanism 326 (FIG. 3). In some embodiments, at least a portion of clip 120 is flexible. For example, a part of tail portion 123 can be flexible. In many embodiments, main portion 121 and tail portion 123 are removably coupled to outer casing 110. In other embodiments, main portion 121 and tail portion 123 are integrally coupled to outer casing 110, and attachment mechanism 326 (FIG. 3) is unnecessary. In these other embodiments, clip 120 is non-removable from outer casing 110.

Clip 120 can be used to connect computer input device 100 to another object. For example, clip 120 can be used to couple computer input device 100 to a computer bag or backpack by sliding part of the computer bag or backpack between main portion 121 and tail portion 123. In another embodiments, computer input device 100 can be coupled to a pocket on a user's shirt or pants by sliding a portion of the pocket between main portion 121 and tail portion 123. By coupling clip 120 to a computer bag, backpack, pocket, belt, or another object, computer input device 100 can be securely transported between locations and decrease the likelihood that a user will lose, forgot, damage, or have stolen computer input device 100.

In numerous examples, main portion 121 can include: (a) a proximal end 161 adjacent to tail portion 123; (b) a distal end 162 opposite proximal end 161; and (c) a protrusion or bump 124 at or near distal end 162.

In the same of different examples, tail portion 123 can include: (a) a proximal end 163 adjacent to main portion 121; (b) a distal end 164 opposite proximal end 163; and (c) a protrusion or bump 125 at or near distal end 164. In some embodiments, proximal end 163 is adjacent to proximal end 161.

In some examples, tail portion 123 is biased towards and in contact with main portion 121 such that a channel or space can be created between tail portion 123 and main portion 121 by moving distal end 164 away from main portion 121. For example, bump 124 can be in contact with bump 125 and a space can be created between bump 124 and bump 125 by moving distal end 164 away from distal end 162.

Tail portion 123 can be configured such that bump 125 is in contact with bump 124 unless distal end 164 is moved away from main portion 121. That is, when bumps 124 and 125 are moved apart, an object can be inserted between main portion 121 and tail portion 123. In the same embodiments, a gap 165 can exist between parts of tail portion 123 and parts of main portion 121 when bump 124 is in contact with bump 125.

In alternative embodiments, distal end 162 of main portion 121 can be in contact with distal end 164 of tail portion 123. In still further embodiments, main portion 121 and tail portion 123 are not in contact with each other. Tail portion 123 can be biased towards main portion 121 in any of these embodiments. In the same or different embodiments, main portion 121 can be biased towards tail portion 123.

In the same or different examples, outer casing 110 and clip 120 can be considered to include: (a) body 190 defining an interior space; (b) a segment 191 coupled to body; and (c) an extension 192 spaced apart from body and coupled to segment 191. Body 190 and extension 192 can define therebetween a channel 193 at an exterior of body 190. In some examples, at least one of first segment and extension are flexible. Other features of computer input device 100 in FIGS. 1 and 2 are described later.

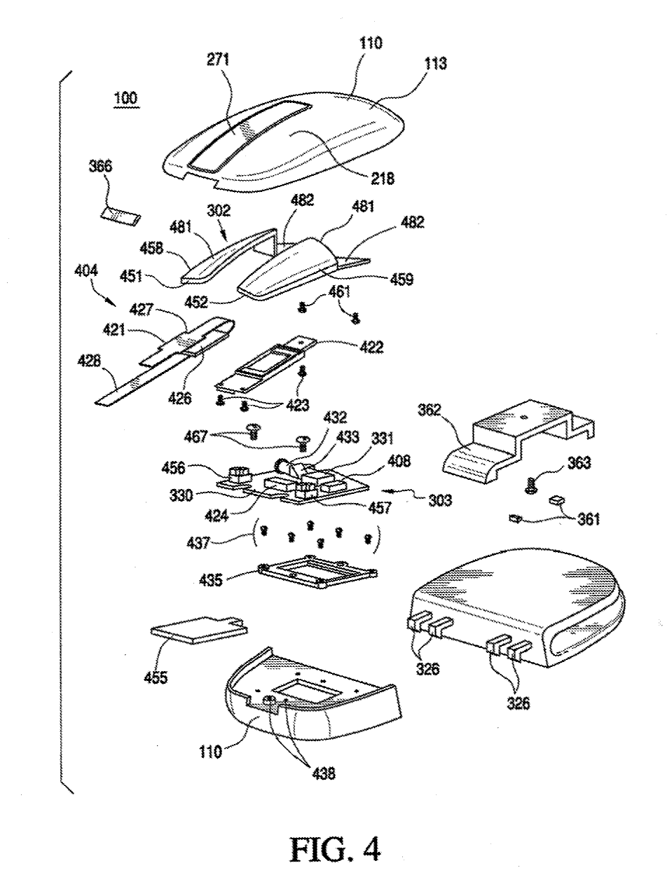

FIG. 3 is a cross-sectional view along line 3-3 of FIG. 2 illustrating computer input device 100, according to the first embodiment. FIG. 4 is an exploded view illustrating computer input device 100, according to the first embodiment.

Referring to FIGS. 3-4, computer input device 100 can further include: (a) one or more buttons 302 (FIG. 3); (b) a movement mechanism 303 (FIG. 3); (c) a scrolling mechanism 404 (FIG. 4); (d) a power source coupling mechanism 360 (FIG. 3); (e) a transmitter/receiver 408 (FIG. 4); and (f) a removable transmitter/receiver 455 (FIG. 4) configured to electrically couple to a computer. In some embodiments, outer casing 110 (FIGS. 1 and 3) can define an interior space or cavity 311 (FIG. 3). Cavity 311 can be located between surface 113 and surface 114.

In various embodiments, movement mechanism 303 is a mechanism configured to detect movement of outer casing. In the same or different embodiments, at least a portion of buttons 302, at least a portion of movement mechanism 303, and at least a portion of scrolling mechanism 404 can be enclosed or located in cavity 311. Movement mechanism 303, buttons 302, and scrolling mechanism 404 are user input mechanisms.

In the embodiment shown in FIGS. 1-4, clip 120 forms at least a portion 116 of surface 114, and movement mechanism 303 (FIG. 3) is adjacent to a portion 117 of surface 114. In the same or different embodiments, buttons 302 (FIG. 3) are adjacent to or form a portion 218 (FIG. 2) of surface 113.

In the example illustrated in FIG. 3, power source coupling mechanism 360 can be used to transfer electrical power from at least one portable power source 390 to computer input device 100. Power source coupling mechanism 360 can include: (a) at least two connectors 361; and (b) a holding structure 362 configured to receive and hold portable power source 390. Each of connectors 361 are mechanically coupled to holding structure 362 such that each of connectors 361 can be coupled to terminals on portable power source 390. In some examples, a screw 363 can be used to couple holding structure 362 to outer casing 110. A wire or other conductor (not shown) can be coupled to connectors 361 and configured to transmit electrical power from portable power source coupling mechanism 360 to a printed circuit board 330.

Outer casing 110 can be configured to removably enclose portable power source 390 in cavity 311. In some embodiments, clip 120 is removably coupled outer casing 110, and computer input device 100 is configured such that portable power source 390 can be placed inside of cavity 311 and coupled to power source coupling mechanism 360 when clip 120 is uncoupled from outer casing 110. In alternative examples, portable power source 390 can be placed in cavity 311 through other openings in outer casing 110. For example, in a different embodiment, the top half of outer casing 110 can be removed to provide access to power source coupling mechanism.

Portable power source 390 can be a removable, disposable, or rechargeable battery in some examples. In one embodiment, portable power source 390 can be charged using connectors 361 when computer input device 100 is not use. In an alternative example, connectors 361 can be connectors capable of being coupled to an electrical outlet or computer when computer input device 100 is not in use For example, portable power source 390 can be recharged while remaining within cavity 311 using inductive or capacitive power transfer technology.

Referring to FIGS. 3 and 4, transmitter/receiver 408 can be configured to communicate with a transmitter/receiver 455. That is, transmitter/receiver 455 can be removed from cavity 311 and coupled to a computer. Transmitter/receiver 408 can communicate information from computer input device 100 to transmitter/receiver 455, which communicates the information to the computer. For example, transmitter/receiver 455 can be a dongle configured to couple to a USB port on the computer. In the same or different examples, transmitter/receivers 408 and 455 can be radio frequency transmitters/receivers.

In some embodiments, outer easing 110 is configured to allow storage of transmitter/receiver 455 inside of cavity 311. For example, outer casing 110 can have a compartment 356 configured to hold transmitter/receiver 455. In some examples, compartment 356 can be accessed through an opening 364 in outer casing 110. Opening 364 can have a cover 366.

In the illustrated embodiment, compartment 356 is located in the front portion of cavity 311, and power source coupling mechanism 360 is located in the rear portion of cavity 311. In other embodiment, compartment 356 can be located in the rear portion of cavity 311, and power source coupling mechanism 360 can be located in the front portion of cavity 311. In yet further examples, both the power source coupling mechanism 360 and compartment 356 can be located in the front, middle, or rear portion of cavity 311.

In other embodiments, computer input device 100 can be configured to be coupled to a computer using a cable, instead of or in addition to transmitters/receivers 408 and 455. Additionally, computer input device could receive power through the cable coupled to the computer and power source coupling mechanism 360 and portable power source 390 could be eliminated.

Referring again to FIGS. 3 and 4, movement mechanism 303 can include: (a) sensor 331; (b) a LED (light emitting diode) 432; (c) a guide 433; (d) a lens frame 435 including a sensor lens 334. In some examples, sensor 331, LED 432, and guide 433 can be coupled to or formed on circuit board 330. In various embodiments, LED 432 emits light into guide 433, and this light is reflected out of outer casing 110 though an aperture 338 in outer casing 110. A portion of the light is reflected off a surface 199 (FIG. 1) and back into sensor 331 through sensor lens 334. Sensor 331 uses the reflected light to calculate the movement of outer casing 110 and computer input device 100.

In this embodiment, lens frame 435 can be coupled to outer casing 110. In one example. Lens frame 435 can be coupled to outer casing 110 by screwing one or more screws 437 through lens frame 435 into screw receptacles 438.

In some embodiments, circuit board 330 can be coupled to outer casing 110. In one example, circuit board 330 is coupled to outer casing 110 by screwing screws 467 through circuit board 330 into screw receptacles 438.

In the embodiment illustrated in FIGS. 1-4, scrolling mechanism 404 uses a touchpad module 421 to provide scrolling capabilities. In other embodiments, other types of scrolling mechanisms can be used to provide scrolling capabilities. Scrolling can be sliding a horizontal or vertical presentation of content, such as text, drawings, or images, across a screen in a computer monitor (not shown) attached to a computer (not shown). Scrolling is often used to show large amounts of data that cannot fit on the screen at the same time. Scrolling mechanism 404 can be located inside of cavity 311 to allow computer input device.

Referring again to FIGS. 3 and 4, scrolling mechanism 404 can include: (a) touchpad module 421; (b) a holder 422; (c) an operations module 424; and (d) screws 423. In some embodiments, touchpad module 421 can include: (a) a sensor region 427; (b) a circuit board region 426 coupled to sensor region 427 and operations module 424; and (c) a wire ribbon region 428 coupled to circuit board region 426. Touchpad module 421 is capable of detecting movement of a linger adjacent to sensor region 427.

In numerous examples, sensor region 427 is adjacent to an inner surface of a portion 271 (FIG. 2) of outer casing 110. In some examples, sensor region 427 can be coupled to the inner surface of portion 271 using an adhesive. In the same or different examples, touchpad module 421 is also held adjacent to the inner surface of portion 271 by screwing holder 422 to outer casing 110 using screws 423.

Sensor region 427 can register the movement of the user's finger on portion 271, and the electronics in circuit board region 426 can convert the movement detected in sensor region 427 into an electrical signal that can be communicated to operations module 424 through wires in wire ribbon region 428. The wires in wire ribbon region 428 can be coupled to operations module 424. Operations module 424 is configured to transfer the movement measured by touchpad module 421 to a computer through transmitters/receivers 408 and 455.

Buttons 302 include right button 458 and a left button 459. End 451 of button 458 can be adjacent to a click module 456. Likewise, end 452 of button 459 can be adjacent to a click module 457. In other embodiments, buttons 302 could include one button, or three or more buttons. In some examples, the number of buttons depends on the needs of the user and/or on the type of computer coupled to computer input device 100.

In many embodiments, buttons 458 and 459 can each include: (a) a button region 481; and (b) a coupling region 482. When a user presses down on button 458 or 459 through portion 218, button region 481 of the respective, one of buttons 458 and 459 are depressed. Depressing button region 481 of buttons 458 or 459 will activate click module 456 or 457, respectively, and register the user action. The user action is converted into an electrical signal by click module 456 or 457 and communicated to a computer through transmitters/receivers 408 and 455.

In several embodiments, buttons 302 can be coupled to outer casing 110 with screws 461. Screws 461 can be screwed through holes in coupling regions 482 into screw receptacles (not shown) in outer casing 110.

In non-illustrated embodiments, buttons 302 can form a portion of exterior 105 of computer input device 100. That is, a portion of buttons 302 can be located outside of cavity 311.

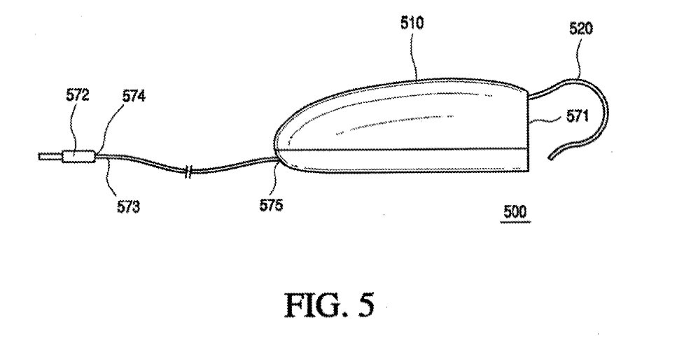

Turning to another embodiment, FIG. 5 is a side view illustrating a computer input device 500, according to a second embodiment. Computer input device 500 can be similar to computer input, device 100 in FIG. 1, except as described below. In this embodiment, computer input device 500 has: (a) an outer casing 510; and (b) a clip 520. Clip 520 is permanently or removably coupled to a side 571 of computer input device. In this example, clip 520 can also be used as a wrist support when a user is using computer input device 500.

Computer input device 500 can be coupled to a computer using a connector 572, and a cable 573 can be used to transmit electrical signals from computer input device 500 to an electrical device (e.g. a computer). In this example, computer input device 500 does not include transmitters/receivers 408 and 455 (FIG. 4). In these embodiments, connector 572 can be coupled to end 574 of cable 573, and end 575 of cable 573 can be coupled to circuit board 330 (FIGS. 3 and 4). Electrical signals indicating the user actions (e.g., clicking buttons 302, moving outer casing 110, or using scrolling mechanism 404) can be commutated to the attached electrical device (e.g., a computer) through connector 572. In a different embodiment, computer input device can include transmitters/receivers 408 and 455 (FIG 4) instead of connector 572 and cable 573.

In some examples, connector 572 can be a standard connector, such as an RS-232C (recommend standard 232C) connector, a PS/2 (personal system/2) connector, an ADB (Apple® desktop bus) connector, or a USB (universal serial bus) connector.

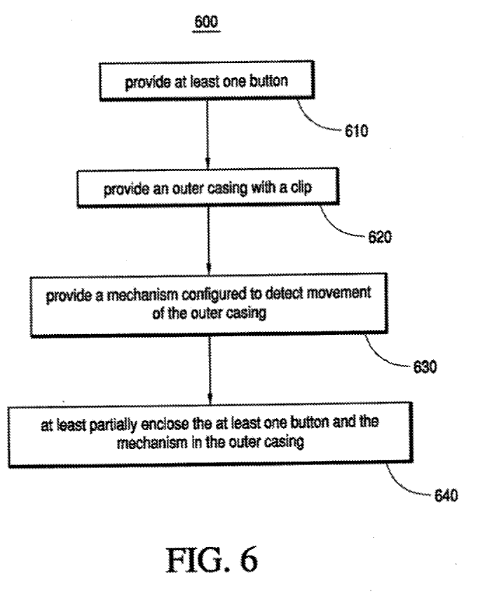

FIG. 6 is a flow chart 600 illustrating an embodiment of a method of manufacturing a computer input device. For example, the computer input device can be identical or similar to computer input device 100 or 500 of FIGS. 1 and 5, respectively.

Flow chart 600 of FIG. 6 includes a step 610 of providing at least one button. As an example, the at least one button can be identical to or similar to buttons 302, as illustrated in FIG. 3.

Subsequently, flow chart 600 of FIG, 6 includes a step 620 of providing an outer casing including a clip. As an example, outer casing 110 can be identical to or similar to outer casing 110 or 510, as illustrated in FIGS. 1 and 5, respectively. The clip can be identical to or similar to clip 120 or 520 of FIGS. 1 and 5, respectively.

In some embodiments, step 620 can include integrally coupling at least a portion of the clip to at least a portion of the outer casing. As an example, the integrally coupling step can include gluing a portion of the clip to the outer casing.

In some embodiments, step 620 can include integrally forming at least a portion of the clip with at least a portion of the outer casing. As an example, the integrally forming step can include forming a portion of the clip and a portion of the outer casing in the same injection molding, transfer molding, or other formation process.

In some examples, step 620 can include providing the clip to include: (a) a main portion; and (b) a tail portion such that the tail portion forms at least a portion of an outer surface of outer casing. For example, the main portion and the tail portion can be identical to or similar to main portion 121 and tail portion 123, respectively, as shown in FIG. 1. In the same or different examples, step 620 can include providing at least a portion of the clip to be removable from the outer casing.

Flow chart 600 of FIG. 6 continues with a step 630 of providing a mechanism configured to detect movement of the outer casing. As an example, the mechanism can be identical to or similar to movement mechanism 303 as illustrated in FIG. 3.

Next, flow chart 600 of FIG. 6 includes a step 640 of at least partially enclosing the at least one button and the mechanism in the outer casing. For example, the enclosure of the at least one button and the mechanism in the outer casing can be identical to or substantially similar to the encasing of buttons 302 and movement mechanism 303 in outer casing 110, as shown in FIG. 3. Furthermore, step 630 can be performed simultaneously with step 610, and other sequences of the steps of flow chart 600 are also possible.

Although the invention has been described with reference to specific embodiments, it will be understood by those skilled in the art that various changes may be made without departing from the spirit or scope of the invention. For example, many other design for clips 120 (FIG. 1) or 520 (FIG, 5) are contemplated. As another example, transmitter/receiver 455 (FIG. 4) can be separate from computer input device 100 (FIGS. 1-4) and, in one embodiment, can be a part of a computer with which computer input device 100 is designed to work. In this embodiment, compartment 356 can hold a removable memory device such as a USB thumb drive for use with the same computer. Additional examples of such changes have been given in the foregoing description. Accordingly, the disclosure of embodiments of the invention is intended to be illustrative of the scope of the invention and is not intended to be limiting. It is intended that the scope of the invention shall be limited only to the extent required by the appended claims. To one of ordinary skill in the art, it will be readily apparent that the computer input devices, computer mice, and methods of manufacturing discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the invention claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A computer input device comprising:
an outer casing comprising:
a first surface;
a second surface; and
a cavity between the first surface and the second surface;
at least one button at the first surface;
a mechanism configured to detect movement of the outer casing and located at the second surface; and
a clip,
wherein:
the mechanism and the at least one button are at least partially located within the cavity.

2. The computer input device of claim 1, wherein:
the clip forms at least a portion of the second surface; and
the clip is integrally coupled to the outer casing.

3. The computer input device of claim 1, wherein:
at least a portion of the clip is flexible.

4. The computer input device of claim 1, wherein:
at least a portion of the clip is removably coupled to the outer casing.

5. The computer input device of claim 1, wherein:
the clip comprises:
a main portion; and
a tail portion with a proximal end adjacent to the main portion and with a distal end opposite the proximal end; and
the clip is configured such that a space can be created between the distal end of the tail portion and the main portion by moving the distal end of the tail portion away from the main portion.

6. The computer input device of claim 5, wherein:
the main portion is integrally coupled to the outer casing.

7. The computer input device of claim 5, wherein:
the main portion comprises:
a proximal end adjacent to the tail portion;
a distal end opposite the proximal end; and
a first bump at the distal end;
the tail portion further comprises a second bump at the distal end;
the clip is configured such that a space exists between the main portion and the trail portion, and
the space is devoid of being located between the first bump and the second bump when the distal end of the tail portion is not moved away from the main portion.

8. The computer input device of claim 1, wherein:
the outer casing further comprises a third surface; and
the clip is located at the third surface.

9. The computer input device of claim 1, further comprises:
a donate,
wherein:
the outer casing is configured to allow storage of the donate inside of the cavity.

10. A computer mouse comprising:
one or more buttons;
a movement sensing mechanism; and
a structure comprising:
a body defining an interior space;
a segment coupled to the body; and
an extension spaced apart from the body and coupled to the segment,
wherein:
at least a portion of the one or more buttons and at least a portion of the movement sensing mechanism are in the interior space of the body; and
the body and the segment define therebetween a channel.

11. The computer input device of claim 10, wherein:
the structure further comprises a first exterior surface; and
the extension forms a first potion of the first exterior surface of the structure.

12. The computer input device of claim 11, wherein:
the movement sensing mechanism is adjacent to a second portion of the first exterior surface of the structure.

13. The computer input device of claim 12, wherein:
the structure farther comprises a second exterior surface opposite the first exterior surface; and
the one or more buttons are adjacent to or form a portion of the second exterior surface.

14. The computer input device of claim 11, wherein:
a first portion of the body, the segment, and the extension are removably coupled the structure.

15. The computer input device of claim 10, wherein:
the body is configured to support a removal power source in the interior space.

16. The computer input device of claim 15, wherein:
a first portion of the body, the segment, and the extension are removably coupled the structure; and
the structure is configured such that the removable power source can be placed inside of the cavity when the first portion of the body, the first segment, and the extension are uncoupled from the structure.

17. The computer input device of claim 10, wherein;
at least one of the segment and the extension are flexible.

18. The computer input device of claim 10, wherein:
the body is configured to receive a dongle.

19. The computer input device of claim 10, wherein:
the body has a first surface and comprises a first protrusion at the first surface;
the extension has an interior surface and comprises a second protrusion at the interior surface; and
the first protrusion is adjacent to the second protrusion.

20. A computer mouse comprising;
a housing comprising a clip; and
two or more user input mechanisms located at least partially within the housing.

21. The computer mouse of claim 20, which:
the clip is integral with the housing.

22. The computer mouse of claim 20, wherein:
the clip is non-removable from the housing.

23. The computer mouse of claim 20, further comprising:
a memory device storably within the housing and removal from the housing.

24. A method of manufacturing a computer input device comprising:
providing at least one button;
providing an outer casing comprising a clip;
providing a mechanism configured to detect movement of the outer casing; and
at least partially enclosing the at least one button and the mechanism in the outer casing.

25. The method of claim 24, wherein:
providing the outer casing comprises:
integrally coupling at least a portion of the clip to at least a portion of the outer casing.

26. The method of claim 24, wherein:
providing the outer casing comprises:
integrally forming at least a portion of the outer casing with at least a portion of the clip.

27. The method of claim 24, wherein:
providing the outer casing comprises:
providing the clip to comprise:
a main portion; and
a tail portion such that the tail portion forms at least a portion of an outer surface of the outer casing.

28. The method of claim 24, wherein:
providing the outer casing comprises:
providing at least a portion of the clip to be removable from the outer casing.
